(19) United States
(12) Patent Application Publication
(10) Pub. No.: US 2023/0238754 A1
(43) Pub. Date: Jul. 27, 2023

(54) POWER STRIP WITH USB PORTS AND ELECTRICAL CORD STORAGE

(71) Applicant: Jeff McLemore, Springtown, TX (US)

(72) Inventor: Jeff McLemore, Springtown, TX (US)

(21) Appl. No.: 17/584,555

(22) Filed: Jan. 26, 2022

(51) Int. Cl. H01R 25/00; H01R 27/00

(52) U.S. Cl. CPC H01R 25/003; H01R 27/00

(57) ABSTRACT

An electric storage power strip device for maintaining cables wound about a plurality of tabs coupled to the electric power strip device includes a power strip elongated for a length. The power strip has a peripheral surface where a plurality of universal serial bus ports is positioned. Furthermore, a plurality of receptacles is positioned on the peripheral surface. Each receptacle of the plurality of receptacles is a power outlet port. The plurality of universal serial bus ports and the plurality of receptacles are in electrical communication with each other. A plurality of thumb tabs is coupled to the peripheral surface. Each thumb tab of the plurality of thumb limits the movement of the wound cords. A plurality of wrap docks is associated to each lateral surface of the pair of lateral surfaces. Each wrap port defines a space for the cords to be stored within.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to electric power strip device and more particularly pertains to a new electric power strip device for maintaining cables wound about a plurality of tabs coupled to the electric power strip device.

### (2) Description of Related Art Including Information Disclosed Under 37 CFR 1.97 and 1.98

The prior art relates to electric power strip device including a variety of electric power strip devices that have a plurality of receptacles or a plurality of universal serial bus ports. In some cases, an electric power strip device may have both of a plurality of receptacle and a plurality of universal serial bus ports. Known prior art lacks an electric power strip device having a plurality of receptacles and a plurality of universal serial bus ports in combination with a plurality of tabs being coupled to the peripheral surface of the electrical power strip device for retaining power cords wound about the tabs.

### BRIEF SUMMARY OF THE INVENTION

An embodiment of the disclosure meets the needs presented above by generally comprising a power strip. The power strip has a peripheral surface. A plurality of universal serial bus ports is positioned on the peripheral surface. Each universal serial bus of the plurality of universal serial bus ports is in electric communication with each other. A plurality of receptacles is positioned on the peripheral surface. Each receptacle of the plurality of receptacles is a power outlet port. The plurality of receptacles is in electric communication with each other. The plurality of universal serial bus ports and the plurality of receptacles are in electrical communication with each other. A plurality of thumb tabs is coupled to the peripheral surface. Each thumb tab of the plurality of thumb is configured for securing the wound cords.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a electric storage power strip device according to an embodiment of the disclosure.

FIG. 2 is a bottom view of an embodiment of the disclosure.

FIG. 3 is a peripheral view of an embodiment of the disclosure.

FIG. 4 is a side view of an embodiment of the disclosure.

FIG. 5 is an alternative top in-use view of an embodiment of the disclosure.

### DETAILED DESCRIPTION OF THE INVENTION

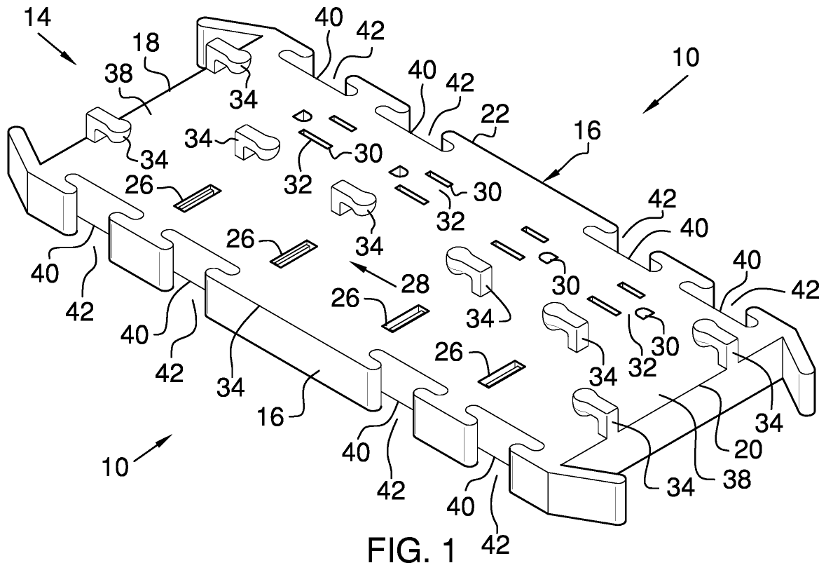

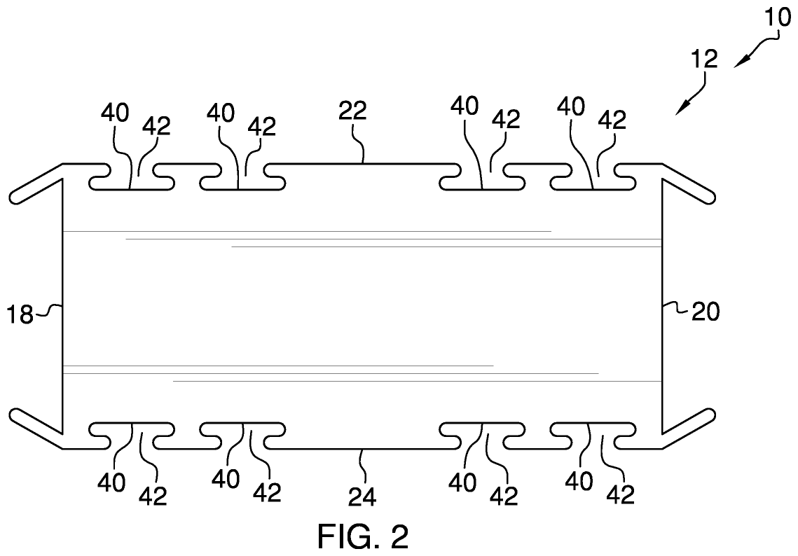

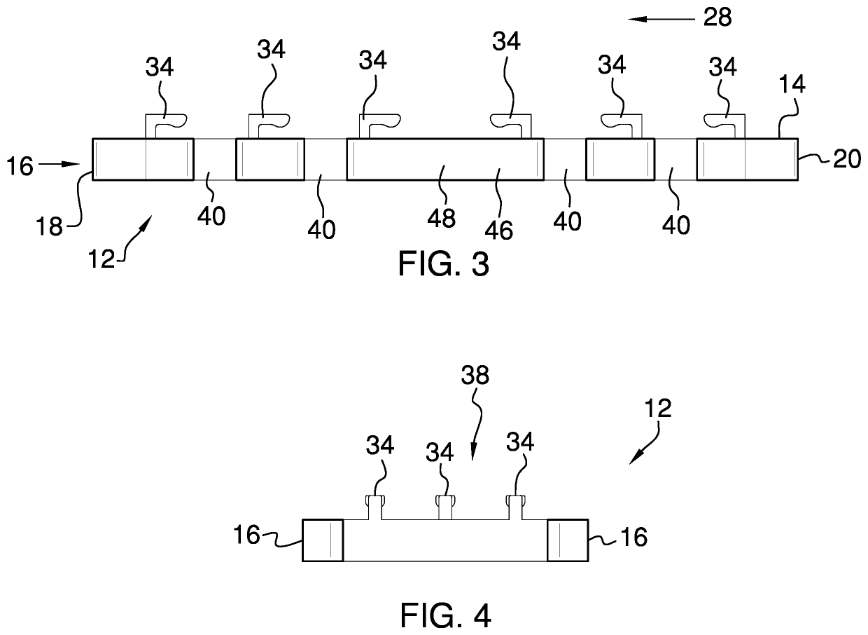

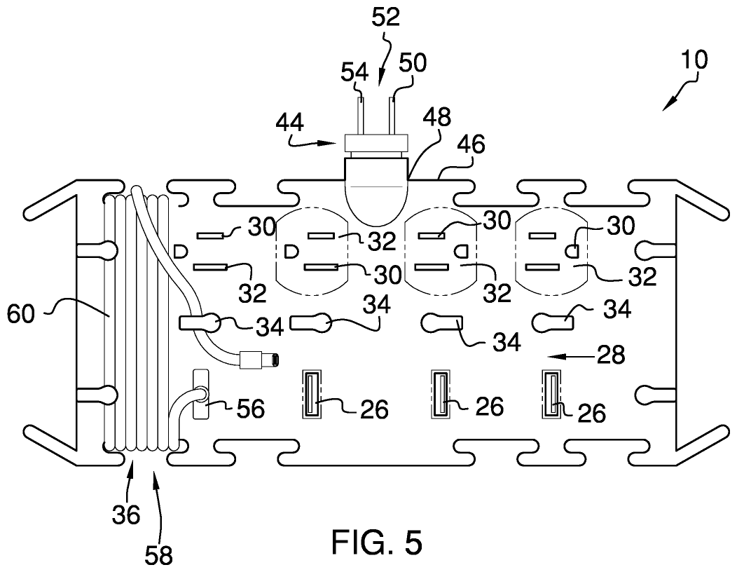

With reference now to the drawings, and in particular to FIGS. 1 through 5 thereof, a new electric power strip device embodying the principles and concepts of an embodiment of the disclosure and generally designated by the reference numeral 10 will be described.

As best illustrated in FIGS. 1 through 5, the electric storage power strip device 10 generally comprises a power strip 12. The power strip 12 has a peripheral surface 14, and a pair of lateral surfaces 16. The pair of lateral surfaces 16 is positioned parallel relative to each other and is positioned perpendicular relative to the peripheral surface 14. The peripheral surface 14 has a left edge 18 and a right edge 20. The left edge 18 and the right edge 20 are positioned parallel to each other. The peripheral surface has a top edge 22 and a bottom edge 24. The top edge 22 and the bottom edge 24 are positioned parallel to each other. The top edge 22 and the bottom edge 24 are positioned perpendicular relative to the right edge 20.

A plurality of universal serial bus ports 26 is coupled to the peripheral surface 14 of the power strip 12. The plurality of universal serial bus ports 26 is positioned proximate to the bottom edge 24 of the peripheral surface 14. Each universal serial bus port of the plurality of universal serial bus ports 26 are in electric communication with each other. The plurality of universal serial bus ports 26 are positioned in an array 28. The array 18 is parallel with the top edge 22 and the bottom edge 24.

A plurality of receptacles 30 is coupled to the peripheral surface 14 of the power strip 12. Each receptacle of the plurality of receptacles 30 is a power outlet port 32. The plurality of receptacles 30 is positioned proximate to the top edge 22. Each receptacle of the plurality of receptacles 30 is in electric communication with each other. The plurality of receptacles 30 and the plurality of universal serial bus ports 26 are in electric communication with each other. The plurality of receptacles 30 is in the array 28 relative to the plurality of universal serial bus ports 26.

A plurality of thumb tabs 34 is coupled to the peripheral surface 14. Each thumb tab of the plurality of thumb tabs 34 protrudes out from the peripheral surface 14. Each thumb tab of the plurality of thumb tabs 34 is configured for securing the wound cords 36. The plurality of thump tabs 34 is positioned in the center 38 of the peripheral surface 14. The plurality of thumb tabs 34 is in the array 28 relative to the plurality of universal serial bus ports 26 and to the plurality of receptacles 30. The plurality of thumb tabs 34 is positioned adjacent to the left edge 18 and the right edge 20 of the peripheral surface 14.

A plurality of wrap docks 40 is associated to the pair of lateral surfaces 16. Each wrap dock of the plurality of wrap docks 40 defines a space 42. Each wrap dock of the plurality of wrap docks 40 are configured for containing the wound cords 36.

A power outlet 44 is coupled to a lateral surface 46 of the pair of lateral surfaces 16. The power outlet 44 is positioned in a center 48 of the lateral surface 46. The power outlet 44 has a plurality of prongs 50. The plurality of prongs 50 is positioned in a center 52 of the power outlet 44. The plurality of prongs 50 is positioned in a circular arrangement 54. The power outlet 44 is configured for attaching to an A/C power supply. The power outlet 44 is in electric communication with the plurality of universal serial bus ports 26 and with the plurality of receptacles 30. The power outlet 44 is an optional element to the electric storage power strip device 10.

In use, the end 56 of a power cord 58 can be inserted into a respective one of the plurality of universal serial bus ports 26 or into a respective one of the plurality of receptacles 30. The body 60 of the power cord 58 is then wound about each lateral side of the pair of lateral sides 16 of the power strip 12. Each thumb tab of the plurality of thumb tabs 34 restrains the body 60 from movement after the power cord 58 has been fully enwrapped around the power strip 12. The power outlet 44 is inserted into the A/C power supply to provide an electric current to the power strip 12. The electric current will flow to each power cord 58 inserted into the power strip 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An electric power strip device comprising:
a power strip, said power strip having a peripheral surface;
a plurality of universal serial bus ports, said plurality of universal serial bus ports being positioned on said peripheral surface, each universal serial bus port of said plurality of universal serial bus ports being electrically connected with each other;
a plurality of receptacles, each of said plurality of receptacles being a power outlet port, said plurality of receptacles being positioned on said peripheral surface, each of said plurality of receptacles being in said electric connection with each other; and
a plurality of thumb tabs, each thumb tab of said plurality of thumb tabs being coupled to said peripheral surface, each thumb tab of said plurality of thumb tabs being configured for securing cords wound around the thumb tabs.

2. The electric power strip device of claim 1, further comprising said power strip having a pair of lateral surfaces, said pair of lateral surfaces being parallel to each other, said pair of lateral surfaces being perpendicular to said peripheral surface.

3. The electric power strip device of claim 1, further comprising said peripheral surface having a left edge and a right edge, said left edge and said right edge being positioned parallel with each other, said peripheral surface having a top edge and a bottom edge, said top edge and said bottom edge being positioned parallel to each other, said top edge and said bottom edge being positioned perpendicular to said right edge.

4. The electric power strip device of claim 3, further comprising said plurality of universal serial bus ports being proximate to said bottom edge, said plurality of universal serial bus ports being positioned in an array, said array being parallel with said top edge and said bottom edge.

5. The electric power strip device of claim 3, further comprising said plurality of receptacles being proximate to said top edge.

6. The electric power strip device of claim 1, further comprising said plurality of receptacles and said plurality of universal serial bus ports being in said electrical connection with each other.

7. The electric power strip device of claim 1, further comprising said plurality of receptacles being in an array relative to said array of said plurality of universal serial bus ports.

8. The electric power strip device of claim 1, further comprising each thumb tab of said plurality of thumb tabs being protruded out from said peripheral surface, said plurality of thumb tabs being positioned in a center of said peripheral surface.

9. The electric power strip device of claim 1, further comprising said plurality of thumb tabs being positioned in said array, said plurality of thumbs being positioned adjacent to said left edge and said right edge of said peripheral surface.

10. The electric power strip device of claim 2, further comprising a plurality of wrap docks, said plurality of wrap docks being associated to said pair of lateral surfaces, each wrap dock of said plurality of wrap docks defining a space, each wrap dock of said plurality of wrap docks being configured for containing the cords.

11. The electric power strip device of claim 2, further comprising a power outlet, said power out being positioned on a lateral surface of said pair of lateral surfaces, said power outlet being positioned in a center relative to said lateral surface, said power outlet having a plurality of prongs, said plurality of prongs being positioned in a circular arrangement, said power outlet being configured for attaching to a A/C power supply.

12. The electric power strip device of claim 11, further comprising said power outlet being in said electric connection with said plurality of universal serial bus ports and with said plurality of receptacles.

13. An electric power strip device comprising:
a power strip, said power strip having a peripheral surface, said power strip having a pair of lateral surfaces, each lateral surface of said pair of lateral surfaces being parallel to each other, said pair of lateral surfaces being perpendicular to said peripheral surface, said peripheral surface having a left edge and a right edge, said left edge and said right edge being positioned parallel with each other, said peripheral surface having a top edge and a bottom edge, said top edge and said bottom edge being positioned parallel to each other, said top edge and said bottom edge being positioned perpendicular to said right edge;
a plurality of universal serial bus ports, said plurality of universal serial bus ports being positioned on said peripheral surface, said plurality of universal serial bus ports being proximate to said bottom edge, each universal serial bus port of said plurality of universal serial bus ports being in an electric connection with each other, said plurality of universal serial bus ports being positioned in an array, said array being parallel with said top edge and said bottom edge;
a plurality of receptacles, each of said plurality of receptacles being a power outlet port, said plurality of receptacles being positioned on said peripheral surface, said plurality of receptacles being proximate to said top edge, each of said plurality of receptacles being in said electric connection with each other, said plurality of receptacles and said plurality of universal serial bus ports being in said electrical connection with each other, said plurality of receptacles being in said array;
a plurality of thumb tabs, each thumb tab of said plurality of thumb tabs being coupled to said peripheral surface, each thumb tab of said plurality of thumb tabs being protruded out from said peripheral surface, each thumb tab of said plurality of thumb tabs being configured for securing the wound cords, said plurality of thumb tabs being positioned in a center of said peripheral surface, said plurality of thumb tabs being positioned in said array, said plurality of thumbs being positioned adjacent to said left edge and said right edge of said peripheral surface;
a plurality of wrap docks, said plurality of wrap docks being associated to said pair of lateral surfaces, each wrap dock of said plurality of wrap docks defines a space, each wrap dock of said plurality of wrap docks being configured for containing the wound cords; and
a power outlet, said power outlet being positioned on a lateral surface of said pair of lateral surfaces, said power outlet being positioned in a center relative to said lateral surface, said power outlet having a plurality of prongs, said plurality of prongs being positioned in a circular arrangement, said power outlet being configured for attaching to a A/C power supply, said power outlet being in said electric connection with said plurality of universal serial bus ports and with said plurality of receptacles.
